(19) United States
(12) Patent Application Publication
(10) Pub. No.: US 2013/0125690 A1
(43) Pub. Date: May 23, 2013

(54) ROBOT ARM ASSEMBLY

(71) Applicant: BO LONG, Shenzhen City (CN)

(72) Inventor: BO LONG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/400,716

(22) Filed: Feb. 21, 2012

(30) Foreign Application Priority Data
Nov. 18, 2011 (CN) 201110367866.2

(51) Int. Cl. B25J 18/00; F16H 1/04

(52) U.S. Cl. 74/423; 74/490.01; 901/26

(57) ABSTRACT

A robot arm assembly includes a base, a first arm rotatably connected to the base, a second arm rotatably connected to the first arm, a third arm rotatably connected to the second arm, a first driving mechanism, a second driving mechanism, and a third driving mechanism. The first driving mechanism includes a first driving member mounted on the base for driving the first arm. The second driving mechanism includes a second driving member mounted on the base and a first transmission shaft securely connected to the second driving member for driving the second arm. The third driving mechanism includes a third driving member mounted on the base and a second transmission shaft securely connected to the third driving member for driving the third arm. The first and second transmission shafts are placed inside the first arm substantially symmetrically with each other about an axis of the first arm.

### BACKGROUND

1. Technical Field

The present disclosure generally relates to robotics, and particularly, to a robot arm assembly applied in an industrial robot.

2. Description of Related Art

An industrial robot may include a plurality of robot arms, a plurality of driving members driving the robot arms, and a plurality of transmission shafts connecting the driving members and the robot arms. Two or more transmission shafts may be sleeved together to save space. However, the above-mentioned robot may have a complicated structure wherein when one of the transmission shafts needs to be repaired, all the transmission shafts need to be disassembled. Disassembling all the transmission shafts may be inconvenient. In addition, because of space limitations, a plurality of gear assemblies may be provided between the driving members and the transmission shafts, or between the transmission shafts and the robot arms. The greater the number of gears used, the greater is the cumulative play or clearance between the teeth. Thus, transmission errors of the robot may become greater and precise repeatability may be lost.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of one embodiment of a robot arm assembly.

FIG. 2 is a cross-section of the robot arm assembly taken along line II-II of FIG. 1.

### DETAILED DESCRIPTION

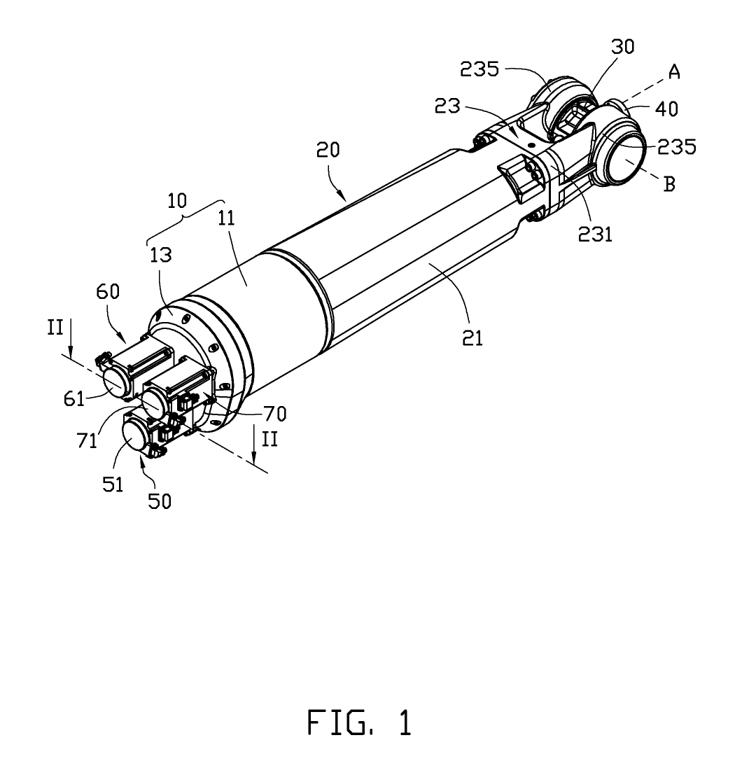

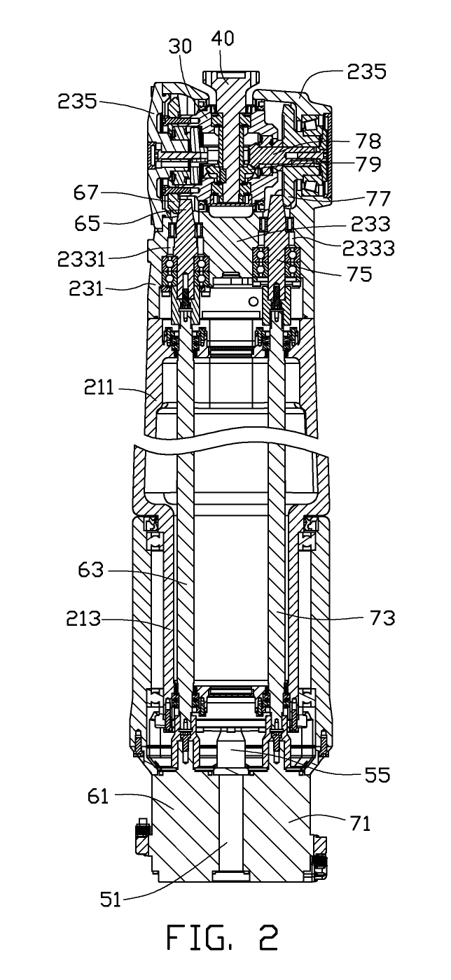

Referring to FIG. 1 and FIG. 2, an embodiment of a robot arm assembly 100 for use in a six-axis robot is shown. The robot arm assembly 100 includes a base 10, a first arm 20, a second arm 30, a third arm 40, a first driving mechanism 50, a second driving mechanism 60, and a third driving mechanism 70. The first arm 20 is rotatable around a first rotation axis A. The second arm 30 is rotatable around a second rotation axis B. The third arm 40 is rotatable around the first rotation axis A. In the illustrated embodiment, the first rotation axis A is substantially perpendicular to the second rotation axis B. The third arm 40 is placed at the distal end of the robot arm assembly 100. An end effector, such as a welding device, a gripper or a cutting tool may be mounted on the distal end of the third arm 40 to perform a predetermined action. The first driving mechanism 50, the second driving mechanism 60, and the third driving mechanism 70 are used to respectively drive the first arm 20, the second arm 30, and the third arm 40 to rotate.

The base 10 includes a main body 11 and a cover portion 13. The main body 11 is substantially a hollow cylinder. The cover portion 13 covers one end of the main body 11 away from the third arm 40.

The first arm 20 includes a first arm portion 21 and a second arm portion 23. The first arm portion 21 includes a main body 211 and an extension portion 213 extending from the end of the main body 211 towards the base 10. The main body 211 is substantially a hollow cylinder. One end of the main body 211 opposite to the extension portion 213 is connected to the second arm portion 23. The extension portion 213 is substantially a hollow cylinder, and is sleeved in and rotatably connected to the main body 11 of the base 10. The second arm portion 23 includes a peripheral wall 231, a mounting wall 233 and two receiving portions 235. One end of the peripheral wall 231 is connected to one end of the first arm portion 21. The mounting wall 233 is plate-like, and is connected to and covers the other end of the peripheral wall 231 opposite to the first arm portion 21. A first mounting hole 2331 and a second mounting hole 2333 are symmetrically defined in the mounting wall 233. The two receiving portions 235 extend from the first mounting hole 2331 and the second mounting hole 2333 away from the first arm portion 21. Each of the two receiving portions 235 is hollow to receive some components of the second arm 30, and a part of the second driving mechanism 60 and the third driving mechanism 70.

Opposite ends of the second arm 30 are rotatably connected to the two receiving portions 235. The third arm 40 is rotatably placed on a central region of the second arm 30, and is perpendicular to the second arm 30.

The first driving mechanism 50 includes a first driving member 51, and a pair of gears 55. The first driving member 51 is securely placed on outside of the cover portion 13. One of the pair of gears 55 is rotatably placed on inside the cover portion 13, and is connected to the first driving member 51. Another one of the pair of gears 55 is securely placed on the extension portion 213, such that the first driving member 51 is capable of driving the first arm 20 to rotate around the first rotation axis A. The pair of gears 55 are bevel gears.

The second driving mechanism 60 includes a second driving member 61, a first transmission shaft 63, a first gear 65, and a second gear 67. The second driving member 61 is securely placed on outside of the cover portion 13 adjacent to the first driving member 51, and is connected to the first transmission shaft 63 to drive the first transmission shaft 63 to rotate. The first transmission shaft 63 is placed in the first arm portion 21. The first gear 65 is rotatably mounted on the periphery of the first mounting hole 2331. One end of the first gear 65 is connected to the first transmission shaft 63, and the other end of the first gear 65 protrudes out from the first mounting hole 2331 towards the second arm 30. The second gear 67 is securely placed on the second arm 30, and is engaged with the end of the first gear 65 towards the second arm 30, such that the second driving member 61 is capable of driving the second arm 30 to rotate around the second rotation axis B. The first gear 65 and the second gear 67 are bevel gears.

The third driving mechanism 70 is similar to the second driving mechanism 60, and is substantially symmetrical with the second driving mechanism 60. The third driving mechanism 70 includes a third driving member 71, a second transmission shaft 73, a third gear 75, a fourth gear 77, a fifth gear 78, and a sixth gear 79. The third driving member 71 is securely placed on outside the cover portion 1, and is substantially symmetrical with the second driving member 61 about the first driving member 51. The third driving member 71 is connected to the second transmission shaft 73 to drive the second transmission shaft 73 to rotate. The second transmission shaft 73 is placed in the first arm portion 21, and is substantially symmetrical with the first transmission shaft 63 about an axis of the first arm portion 21. The third gear 75 is rotatably mounted on the periphery of the second mounting hole 2333. One end of the third gear 75 is connected to the second transmission shaft 73, and the other end of the third gear 75 protrudes out from the second mounting hole 2333 towards the second arm 30. The fourth gear 77 is rotatably placed on one of the two receiving portions 235, and is engaged with the end of the third gear 75 adjacent to the second arm 30. The fifth gear 78 is rotatably placed on each of the two receiving portions 235 on which the fourth gear 77 is placed, and is connected to the fourth gear 77. The sixth gear 79 is securely mounted on the third arm 40, and is engaged with the fifth gear 78. Thus, the third driving member 71 drives the third arm 40 to rotate around the first rotation axis A by means of the second transmission shaft 73, the third gear 75, the fourth gear 77, the fifth gear 78, and the sixth gear 79. The third gear 75, the fourth gear 77, the fifth gear 78, and the sixth gear 79 are bevel gears.

The first transmission shaft 63 and the second transmission shaft 73 are placed inside the first arm 20, and are substantially symmetrical with each other about the axis of the first arm portion 21 of the first arm 20. Thus, the second driving member 61 and the third driving member 71 are symmetrically placed on the base 10, and the second driving member 61, the third driving member 71 are directly connected to the transmission shafts the first transmission shaft 63, the second transmission shaft 73 without additional gears. In addition, the number of gears necessary between the first transmission shaft 63, the second transmission shaft 73 and the second arm 30, the third arm 40 is less. Therefore, the number of gears used in the robot arm assembly 100 is less, the cumulative play or clearance is lower, such that loss of precision through transmission errors is much lower. Furthermore, when one of the driving mechanisms needs to be repaired, the driving mechanisms can be detached or taken down separately, which is very important for maintenance.

Finally, while the embodiments have been described and illustrated, the disclosure is not to be construed as being limited thereto. Various modifications can be made to the embodiment by those skilled in the art without departing from the true spirit and scope of the disclosure as defined by the appended claims.

What is claimed is:

1. A robot arm assembly, comprising:
a base;
a first arm rotatably connected to the base;
a second arm rotatably connected to the first arm;
a third arm rotatably connected to the second arm;
a first driving mechanism comprising a first driving member mounted on the base for driving the first arm;
a second driving mechanism comprising a second driving member mounted on the base, and a first transmission shaft securely connected to the second driving member, the first transmission shaft being capable of driving the second arm to rotate; and
a third driving mechanism comprising a third driving member mounted on the base, and a second transmission shaft securely connected to the third driving member, the second transmission shaft being capable of driving the third arm to rotate, the first transmission shaft and the second transmission shaft being placed inside the first arm, and the first transmission shaft and the second transmission shaft being substantially symmetrically with each other about an axis of the first arm.

2. The robot arm assembly of claim 1, wherein the second driving member is substantially symmetrical with the third driving member about the first driving member.

3. The robot arm assembly of claim 1, wherein the first arm comprises a first arm portion, the first arm portion is substantially hollow, the first transmission shaft and the second transmission shaft are placed inside the first arm portion, and the first transmission shaft and the second transmission shaft are substantially symmetrically with each other about an axis of the first arm portion.

4. The robot arm assembly of claim 3, wherein the first arm portion comprises a main body and an extension portion extending from the main body towards the base, the extension portion is sleeved in the base, and the first driving member is securely connected to the extension portion for rotatably driving the first arm.

5. The robot arm assembly of claim 3, wherein the first arm further comprises a second arm portion; the second arm portion comprises a peripheral wall, a mounting wall, and two receiving portions; one end of the peripheral wall is connected to one end of the first arm portion away from the base; the mounting wall is connected to and covers another end of the peripheral wall; two mounting holes are defined in the mounting wall; each of the two receiving portions extends from each of the two mounting holes away from the first arm portion; and each end of the second arm is rotatably connected to each of the two receiving portions.

6. The robot arm assembly of claim 5, wherein the second driving mechanism further comprises a first gear and a second gear engaged with the first gear, the first gear is rotatably mounted on a periphery of one of the two mounting holes of the first arm, and the second gear is securely placed on the second arm.

7. The robot arm assembly of claim 6, wherein the third driving mechanism comprises a third gear and a fourth gear engaged with the third gear, the third gear is rotatably mounted on a periphery of another one of the two mounting holes of the first arm, and the fourth gear is securely placed on the third arm.

8. The robot arm assembly of claim 7, wherein the third arm is rotatably mounted on the second arm.

9. The robot arm assembly of claim 8, wherein the fourth gear is rotatably mounted on one of the two receiving portions of the first arm.

10. The robot arm assembly of claim 7, wherein the third gear and the fourth gear of the third driving mechanism are bevel gears.

11. A robot arm assembly, comprising:
a base;
a first arm rotatably connected to the base, and comprising a first arm portion, the first arm portion being substantially hollow;
a second arm rotatably connected to the first arm;
a third arm rotatably connected to the second arm;
a first driving mechanism comprising a first driving member mounted on the base for driving the first arm;
a second driving mechanism comprising a second driving member mounted on the base, and a first transmission shaft securely connected to the second driving member, the first transmission shaft being capable of driving the second arm to rotate; and
a third driving mechanism comprising a third driving member mounted on the base, and a second transmission shaft securely connected to the third driving member, the second transmission shaft being capable of driving the third arm to rotate, wherein the second driving member is substantially symmetrical with the third driving member about the first driving member, the first transmission shaft and the second transmission shaft are placed inside the first arm portion, and the first transmission shaft and the second transmission shaft are substantially symmetrically with each other about an axis of the first arm portion.

12. The robot arm assembly of claim 11, wherein the first arm portion comprises a main body and an extension portion extending from the main body towards the base, the extension portion is sleeved in the base, and the first driving member is securely connected to the extension portion for rotatably driving the first arm.

13. The robot arm assembly of claim 11, wherein the first arm further comprises a second arm portion; the second arm portion comprises a peripheral wall, a mounting wall, and two receiving portions; one end of the peripheral wall is connected to one end of the first arm portion away from the base; the mounting wall is connected to and covers another end of the peripheral wall; two mounting holes are defined in the mounting wall; each of the two receiving portions extends from each of the two mounting holes away from the first arm portion; and each end of the second arm is rotatably connected to each of the two receiving portions.

14. The robot arm assembly of claim 13, wherein the second driving mechanism further comprises a first gear and a second gear engaged with the first gear, the first gear is rotatably mounted on a periphery of one of the two mounting holes of the first arm, and the second gear is securely placed on the second arm.

15. The robot arm assembly of claim 14, wherein the third driving mechanism comprises a third gear and a fourth gear engaged with the third gear, the third gear is rotatably mounted on a periphery of another one of the two mounting holes of the first arm, and the fourth gear is securely placed on the third arm.

16. The robot arm assembly of claim 15, wherein the third arm is rotatably mounted on the second arm.

17. The robot arm assembly of claim 16, wherein the fourth gear is rotatably mounted on one of the two receiving portions of the first arm.

18. The robot arm assembly of claim 15, wherein the third gear and the fourth geaare bevel gears.
